(19) United States
(12) Patent Application Publication
(10) Pub. No.: US 2009/0127522 A1
(43) Pub. Date: May 21, 2009

(54) Apparatus for Lifting a Vehicle

(76) Inventor: Lee Sisson, Saint George, UT (US)

Correspondence Address: Jay M. Schloff;Intellipex PLLC, Suite 245, 30200 Telegraph Road, Bingham Farms, MI, 48025, US

(21) Appl. No.: 11/941,466

(22) Filed: Nov. 16, 2007

(51) Int. Cl. B66F 7/06

(52) U.S. Cl. 254/91

(57) ABSTRACT

Dislosed is an apparatus for lifting a vehicle. The apparatus comprises a frame assembly, an arm assembly and a lever. The frame assembly comprises a pair of distanced apart frame links and a plurality of connecting members connected in-between the pair of frame links. The arm assembly is coupled to the frame assembly for providing support to the frame assembly. The lever coupled to a connecting member of the plurality of connecting members, is capable of pivotally rotating the frame assembly from a rest position to an upright position. The apparatus is positioned below a frame of the vehicle and the frame assembly is rotated from the rest position to the upright position to lift the vehicle above a ground surface.

### FIELD OF THE INVENTION

The present invention generally relates to a vehicle maintenance apparatus, and, more particularly, to an apparatus for lifting a vehicle.

### BACKGROUND OF THE INVENTION

Vehicles need to be examined periodically for maintenance purposes. Vehicle maintenance checks may be carried out at vehicle owner's premises or may be carried out at a service station. Performing maintenance checks, also known as servicing a vehicle, may involve performing a thorough check of all the different components of the vehicle and as such, may require parts to be adjusted or even replaced. The vehicle may be placed on a ground surface or may be lifted above the ground surface for servicing purposes.

Servicing a vehicle without lifting the vehicle requires considerable effort on part of a person servicing the vehicle. For instance, the person may need to slide below a frame of the vehicle and perform servicing operations. In such a position, the person may suffer physical strain as the frame of the vehicle is designed to offer limited space below the frame of the vehicle. On account of uncomfortable position, the speed of servicing operations is reduced, rendering the servicing operations inefficient. Lifting the vehicle above the ground surface precludes the need to bend or slide below the frame of the vehicle, resulting in minimal physical strain as well as increased speed of servicing operations. Accordingly, there exists a need for an apparatus for enabling lifting of a vehicle above the ground surface for servicing operations.

In case of motorcycles, servicing operations are performed by tilting a motorcycle to an inclined position. In the inclined position, the motorcycle is supported by a stand. Such a position of the motorcycle poses serious trip hazards and may injure a person servicing the motorcycle. Apparatuses, such as a jack used for lifting motorcycles, render the position of such motorcycles unstable, and these motorcycles may collapse under their own weight. Accordingly, there exists a need for an apparatus to enable lifting of vehicles such as motorcycles in an easy, safe and reliable manner. There also exists a need for an apparatus enabling lifting of vehicles to preclude trip hazards and ensure safety of vehicle as well as personnel servicing the vehicle.

Furthermore, there exists a need for a portable vehicle lifting apparatus to enable the vehicle owner to perform repair operations or maintenance work at the vehicle owner's premises or even on the road. Also, the apparatus may be designed to lift the vehicle to a suitable height above the ground surface so as to preclude the need to bend or slide below the frame of the vehicle, thereby ensuring minimal physical strain.

### SUMMARY OF THE INVENTION

An object of the present invention is to provide an apparatus for lifting a vehicle.

Another object of the present invention is to provide an apparatus enabling lifting of a vehicle precluding trip hazards and safety hazards.

Yet another object of the present invention to provide an apparatus operable by a single person for lifting a vehicle.

Still another object of the invention to provide a portable apparatus for lifting a vehicle.

In view of foregoing disadvantage inherent in the prior art, the general purpose of the present invention is to provide an apparatus for lifting a vehicle, to include all the advantages of the prior art, and overcome the drawbacks inherent therein. The apparatus includes a frame assembly, an arm assembly and a lever. The frame assembly includes a pair of frame links and a plurality of connecting members. The pair of frame links is distanced apart from each other and each connecting member of the plurality of connecting members connected in-between the pair of frame links. The arm assembly is coupled to the frame assembly for providing support to the frame assembly. The arm assembly includes at least one arm link and a support stand. A first end portion of the at least one arm link is hinged to the frame assembly and the support stand is coupled to a second end portion of the at least one arm link. The lever is coupled to a connecting member of the plurality of connecting members. The lever is capable of pivotally rotating the frame assembly from a rest position to an upright position. The apparatus is positioned below a frame of the vehicle and the frame assembly is rotated from the rest position to the upright position for lifting the vehicle from a ground surface.

The support stand coupled to the at least one arm link supports the frame assembly in the upright position. The support stand provides the desired stability to the frame assembly in the upright position, thereby precluding trip hazards and safety hazards.

The frame assembly, the arm assembly and the lever configuring the apparatus are designed to be operable by a single person. Further, the apparatus is designed to be portable. The vehicle owner may perform servicing operations using the apparatus at the vehicle owner's premises or even on-road.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 illustrates a perspective view of an apparatus for lifting a vehicle, in accordance with an embodiment of the present invention;

FIG. 2 illustrates a perspective view of the apparatus with a frame assembly in a rest position, in accordance with an embodiment of the present invention;

FIG. 3A illustrates a perspective view of the apparatus positioned below a frame of a motorcycle with the frame assembly in the rest position, in accordance with an embodiment of the present invention;

FIG. 3B illustrates a perspective view of the apparatus with the frame assembly rotated to an upright position from the rest position, in accordance with an embodiment of the present invention;

FIG. 3C illustrates a position of a motorcycle for maneuvering a support stand of an arm assembly of the apparatus, in accordance with an embodiment of the present invention; and

FIG. 3D illustrates a perspective view of the apparatus with the motorcycle in a lifted condition, in accordance with an embodiment of the present invention.

Like reference numerals refer to like parts throughout the description of several views of the drawings.

### DETAILED DESCRIPTION OF THE INVENTION

The exemplary embodiments described herein detail for illustrative purposes and are subject to many variations in structure and design. It should be emphasized, however, that the present invention is not limited to an apparatus for lifting a vehicle, as shown and described. It is understood that various omissions and substitutions of equivalents are contemplated as circumstances may suggest or render expedient, but these are intended to cover the application or implementation without departing from the spirit or scope of the claims of the present invention. Also, it is to be understood that the phraseology and terminology used herein is for the purpose of description and should not be regarded as limiting. The terms “a” and “an” herein do not denote a limitation of quantity, but rather denote the presence of at least one of the referenced item.

The present invention provides an apparatus for lifting a vehicle. The apparatus includes a frame assembly, an arm assembly and a lever. The frame assembly includes a pair of frame links and a plurality of connecting members. The pair of frame links is distanced apart from each other and each connecting member of the plurality of connecting members connected in-between the pair of frame links. The arm assembly is coupled to the frame assembly for providing support to the frame assembly. The arm assembly includes at least one arm link and a support stand. A first end portion of the at least one arm link hinged to the frame assembly and the support stand is coupled to a second end portion of the at least one arm link. The lever is coupled to a connecting member of the plurality of connecting members. The lever is capable of pivotally rotating the frame assembly from a rest position to an upright position. The apparatus is positioned below a frame of the vehicle and the frame assembly rotated from the rest position to the upright position for lifting the vehicle from a ground surface. The support stand coupled to the at least one arm link of the arm assembly supports the frame assembly in the upright position.

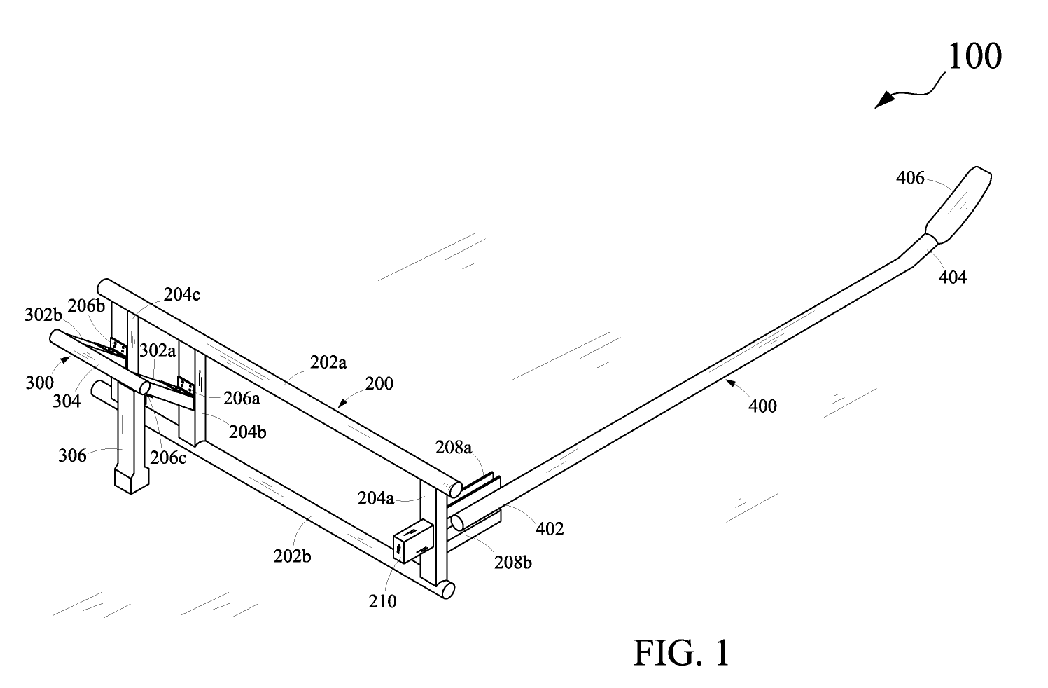

FIG. 1 illustrates a perspective view of an apparatus 100 for lifting a vehicle, in accordance with an embodiment of the present invention. The apparatus 100 includes a frame assembly 200, an arm assembly 300 and a lever 400. The frame assembly 200 includes a pair of frame links such as a frame link 202a and a frame link 202b and a plurality of connecting members such as a connecting member 204a, a connecting member 204b and a connecting member 204c. The frame links 202a and 202b are hereinafter collectively referred to as frame links 202. The connecting members 204a, 204b and 204c hereinafter collectively referred to as plurality of connecting members 204. The frame links 202 are distanced apart from each other and the plurality of connecting members 204 are connected in-between the frame links 202.

The arm assembly 300 includes an arm link 302a, an arm link 302b, an arm link connecting member 304 and a support stand 306. Each of the arm link 302a and the arm link 302b includes a first end portion and a second end portion. The first end portion of the arm link 302a and the first end portion of the arm link 302b are hinged to the frame assembly 200. More specifically, the first end portion of the arm link 302a and the first end portion of the arm link 302b are hinged to the connecting member 204b and the connecting member 204c of the frame assembly 200, respectively. The arm link connecting member 304 connects second end portions of the arm link 302a and the arm link 302b. The support stand 306 is hinged to the arm link 302a at the second end portion of the arm link 302a. The lever 400 is coupled to the connecting member 204a. A fastening mechanism secures a bottom end portion 402 of the lever 400 to the connecting member 204a.

The frame links 202 may be arranged in a longitudinally parallel arrangement as depicted in FIG. 1. Examples of the frame links 202 may include iron rods or other metal links, designed to sustain a load such as weight of a motorcycle. In one embodiment of the present invention, the frame links 202 are iron rods and the plurality of connecting members 204 are welded in-between the iron rods.

FIG. 1 depicts the arm assembly 300 including the arm link 302a, the arm link 302b and the arm link connecting member 304, for providing reinforcing support to a frame of a vehicle in a lifted condition. The arm assembly 300 may be designed to include any number of arm links such as arm link 302a, one or more arm link connecting members such as arm link connecting member 304 and a support stand 306. Alternatively, the arm assembly 300 may be designed to include only one arm link and a support stand. It will be evident to those skilled in the art that suitable reinforcement may be needed to support the frame of the vehicle in case of a configuration of an arm assembly with one arm link and a support stand coupled to the one arm link.

Further, FIG. 1 depicts the first end portion of the arm link 302a hinged to an intermediate portion of the connecting member 204b using a hinge 206a, and the first end portion of the arm link 302b hinged to an intermediate position of the connecting member 204c using a hinge 206b respectively. It will be evident to a person skilled in the art that first end portions of the arm link 302a and the arm link 302b may be coupled to the frame assembly 200 at a variety of positions on the frame assembly 200. For instance, the first end portions of the arm link 302a and the arm link 302b may be coupled to the frame link 202a of the frame assembly 200.

In one embodiment of the present invention, the arm link connecting member 304 is welded to the second end portions of the arm link 302a and the arm link 302b. In one embodiment of the present invention, the support stand 306 is coupled to the second end portion of the arm link 302b using a hinge 206c. Further support stand 306 may be coupled to the second end portion of the arm link 302a using any coupling arrangement allowing the support stand 306 to freely rotate about the second end portion of the arm link 302a.

The lever 400 is coupled to the connecting member 204a using a flange arrangement. The flange arrangement includes a flange 208a and a flange 208b. The flanges 208a and 208b are hereinafter collectively referred to as flanges 208. The flanges 208 may be welded to the connecting member 204a. The flanges 208 are spaced apart from each other configuring a channel adapted to removably receive the bottom end portion 402 of the lever 400. The fastening mechanism such as a bolt arrangement is further provided to secure the bottom end portion 402 of the lever 400. The top end portion 404 of the lever 400 is provided with a detachable grip 406 for facilitating ease of holding the lever 400.

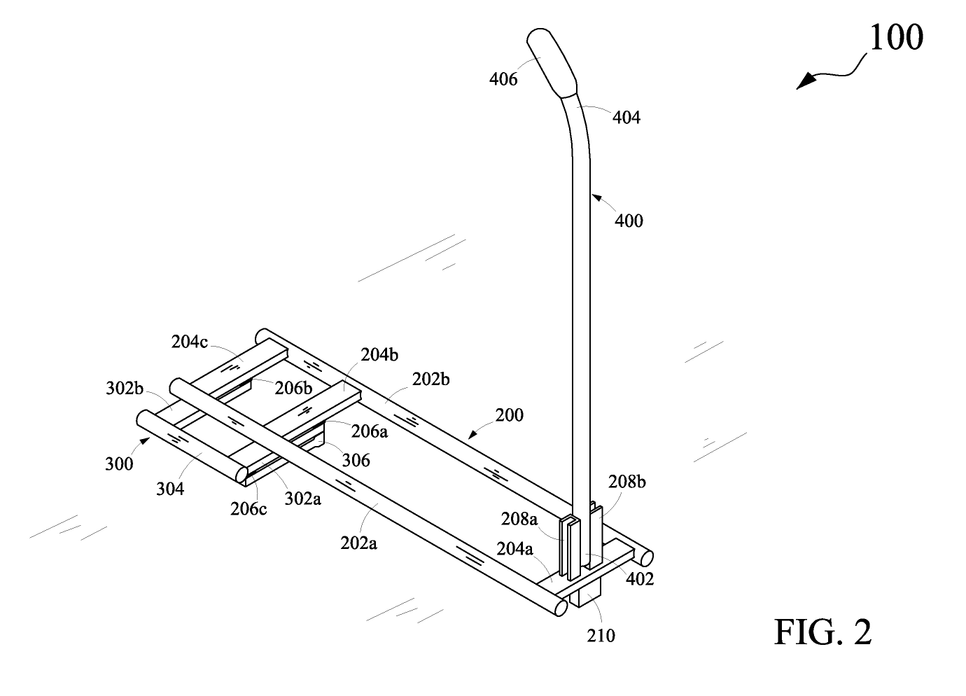

The lever 400 is capable of rotating the frame assembly 200 from a rest position to an upright position. The frame assembly 200 is depicted in the upright position in FIG. 1. The lever 400 is in a horizontal position in the upright position of the frame assembly 200. The lever 400 may be rotated to assume a vertical position for rotating the frame assembly 200 to the rest position. The connecting member 204a is configured with a support element 210 for supporting the lever 400 in the vertical position. The frame assembly 200 rotated to the rest position is depicted in FIG. 2.

FIG. 2 illustrates a perspective view of the apparatus 100 of FIG. 1 with the frame assembly 200 in the rest position, in accordance with an embodiment of the present invention. In the rest position, the lever 400 is positioned away from a ground surface with the frame assembly 200 resting on the support element 210 and on the arm assembly 300.

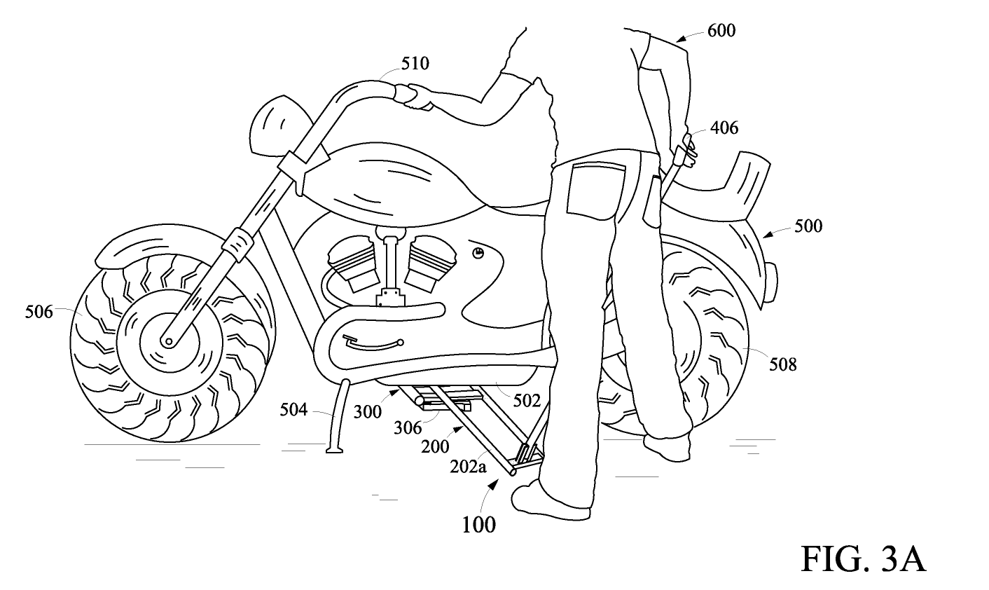

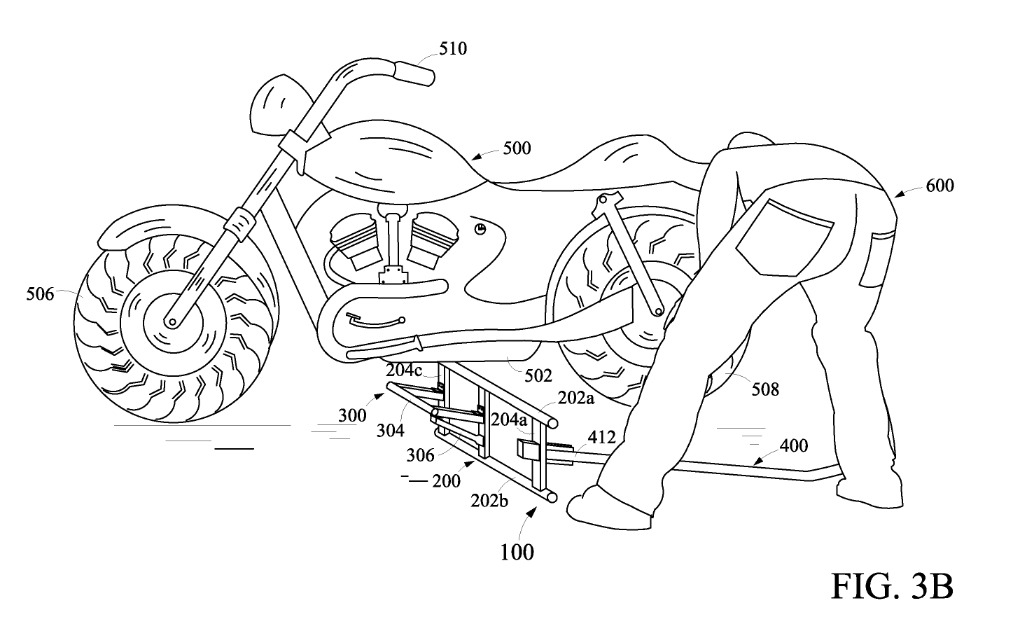

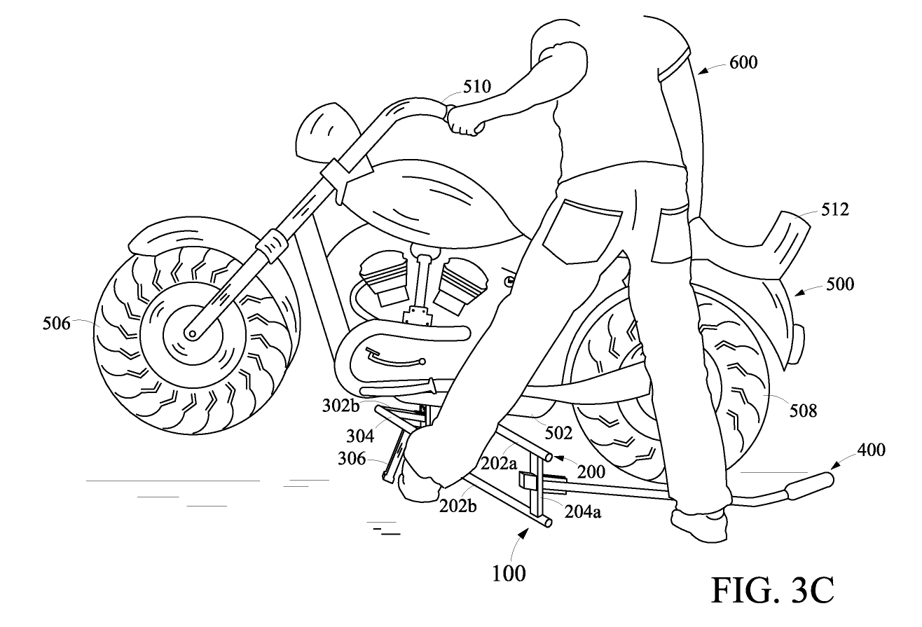

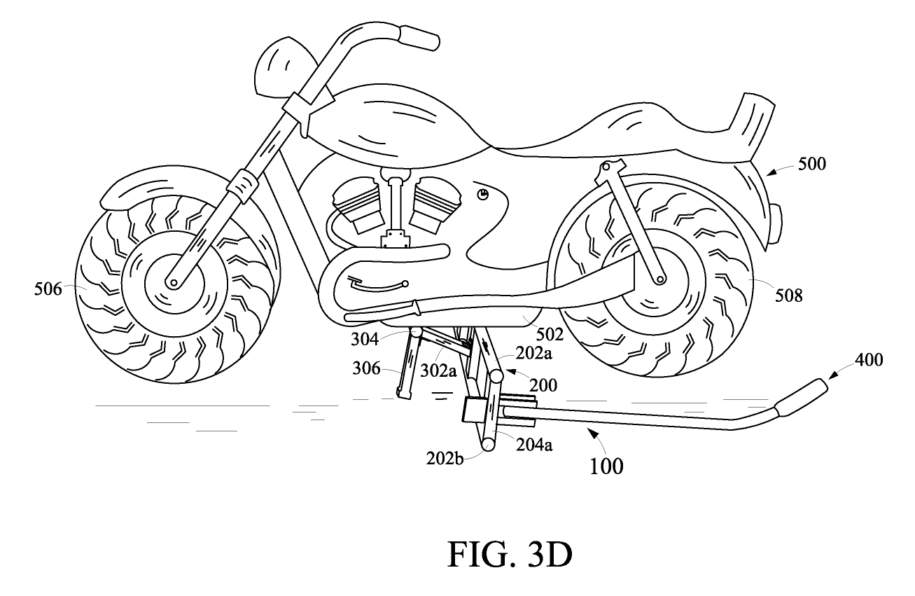

The arm assembly 300 assumes a folded state in the rest position, enabling the frame assembly 200 to rest on the ground surface. More specifically, in the folded state, the second end portion of the arm link 302a and the second end portion of the arm link 302b swing towards the frame link 202a using the hinge 206a and the hinge 206b respectively. The arm link connecting member 304 assumes a longitudinally parallel position to the frame link 202a and is positioned adjacent to the frame link 202a. Further, the support stand 306 is positioned longitudinally parallel to the connecting member 204b and adjacent to the connecting member 204b with the help of hinge 206c. The arm assembly 300 in the folded state enables the frame assembly 200 to rest on the ground surface as depicted in FIG. 2. The frame assembly 200 in the rest position serves as a convenient way for positioning the apparatus 100 below the surface of a frame of the vehicle. The apparatus 100 positioned below a frame of a motorcycle 500 is depicted in FIG. 3A.

FIGS. 3A, 3B, 3C and 3D provide a pictorial representation of various stages involved in lifting the motorcycle 500 above the ground surface using the apparatus 100 of FIG. 1. FIGS. 3A, 3B and 3C depict a person 600 maneuvering the apparatus 100 to lift the motorcycle 500 above the ground surface. It will be obvious to a person skilled in the art that the person 600 is an exemplary inclusion in FIGS. 3A, 3B and 3C to illustrate the lifting of the motorcycle 500 above the ground surface using the apparatus 100.

FIG. 3A illustrates a perspective view of the apparatus 100 of FIG. 1 positioned below a frame 502 of the motorcycle 500 with the frame assembly 200 of the apparatus 100 in the rest position, in accordance with an embodiment of the present invention. The motorcycle 500 may be kept in a standing position using a stand 504 and the apparatus 100 may be slid below the frame 502 of the motorcycle 500 in-between a front wheel 506 and a rear wheel 508 of the motorcycle 500. The apparatus 100 may be positioned below the frame 502 by the person 600 holding the lever 400 using the detachable grip 406 on the top end portion 404 of the lever 400. The person 600 may hold the lever 400 with one hand and a motorcycle handle bar 510 with the other hand as depicted in FIG. 3A. Such a position enables the person 600 to push the lever 400 towards the ground surface to rotate the frame assembly from the rest position to the upright position.

FIG. 3B illustrates a perspective view of the apparatus 100 of FIG. 1 with the frame assembly 200 rotated from the rest position to the upright position, in accordance with an embodiment of the present invention. The person 600 pushes the lever 400 towards the ground surface to rotate the frame assembly 200 to the upright position depicted in FIG. 3B from the rest position depicted in FIG. 3A. The lever 400 is coupled to the connecting member 204a with the bottom end portion 402 secured to the connecting member 204a using the fastening mechanism. Pushing the lever 400 towards the ground surface results in raising the connecting member 204a coupled with the lever 400. The connecting member 204a connected in-between the frame links 202, in turn, rotates the frame assembly 200 to assume the upright position. The frame link 202a of the frame assembly 200 makes contact with the frame 502 of the motorcycle 500 and lifts the rear wheel 508 of the motorcycle 500 above the ground surface when the frame assembly 200 assumes the upright position.

FIG. 3C illustrates a position of the motorcycle 500 for maneuvering the support stand 306 of the arm assembly 300, in accordance with an embodiment of the present invention. As explained in conjunction with FIG. 3B, the rear wheel 508 of the motorcycle 500 is lifted and the frame 502 rests on the frame assembly 200 when the frame assembly 200 is in the upright position. The person 600 may then apply pressure on a seating arrangement 512 of the motorcycle 500 to ground the rear wheel 508 and lift the front wheel 506 above the ground surface. Such a position of the motorcycle 500 with the front wheel 506 in the lifted condition facilitates maneuvering the arm assembly 300, preferably by a foot of the person 600.

The second end portions of the arm links 302a and 302b may be positioned away from the frame assembly 200 to support the frame 502 of the motorcycle 500 on the arm link connecting member 304. The person 600 may further push the support stand 306 away from the frame assembly 200 to support the apparatus 100 and, more specifically, support the frame assembly 200. The person 600 may then release the pressure on the seating arrangement 512 to allow the rear wheel 508 to return to a lifted condition. On releasing the pressure, the frame 502 of the motorcycle 500 rests on the arm link connecting member 304 and the frame link 202a of the frame assembly 200. The motorcycle 500 with the front wheel 506 and the rear wheel 508 in the lifted condition with the frame 502 resting on the frame assembly 200 is depicted in FIG. 3D.

FIG. 3D illustrates a perspective view of the apparatus 100 with the motorcycle 500 in a lifted condition, in accordance with an embodiment of the present invention. As explained in conjunction with FIG. 3C, the frame 502 of the motorcycle 500 rests on the arm link connecting member 304 and the frame link 202 with the front wheel 506 and the rear wheel 508 in the lifted condition. The support stand 306 provides reinforcing support to the apparatus 100. Such a positioning of the motorcycle 500 facilitates performing servicing or repair operations precluding the need to bend down or perform any physical straining activity. Further, the stability of the motorcycle 500 precludes any trip hazards or safety hazards. Also, the apparatus 100 is portable and as such may be used by a single person such as the person 600 for performing servicing operations on the motorcycle 500.

It will be evident to a person skilled in the art that though the apparatus 100 is depicted to lift the motorcycle 500, vehicles such as mopeds, scooters and the like may be lifted using the apparatus 100. Further, shapes and sizes of various components of the apparatus 100 such as length and width of the plurality of connecting members 204 may vary with distance of a frame of a vehicle from a ground surface. Furthermore, the apparatus 100 may be powder coated with a variety of different colors to suit a user's preference. Also, various components of the apparatus 100 may be composed of suitable reinforcing material such as iron, aluminum, or any such other material capable of sustaining loads such as a weight of a vehicle.

In an exemplary embodiment of the present invention, the apparatus 100 may include components having the following dimensions for lifting a motorcycle weighing around 900 lbs: The frame links 202 may have a diameter of 1.25 inch (in) and a length of 30 in. The plurality of connecting members 204 may have a length of about 4 in to about 9 in and a rectangular cross-section of 1 in by 1.25 in. The channel configured by the flanges 208a and 208b may have a height of 4 in. The flange such as flange 208a includes three metal strips connected in a U-shaped arrangement. Width of the metal strip configuring a base of the U-shaped arrangement is 1 in and width of the metal strips configuring sides of the U-shaped arrangement is 0.5 in.

The arm links 302a and 302b may have a length of about 4 in to about 9 in and a rectangular cross-section of 1 in by 2 in. The arm link connecting member 304 may have a diameter of 1.25 in and a length of 13 in. The support stand 306 may have a length of about 4 in to about 10 in and a rectangular cross-section of 1 in by 2 in. The hinges 206a, 206b and 206c may be 2 in×2 in wide. The lever 400 may have a diameter of 1.25 in and a length of about 43 in to about 48 in. Further, the support element 210 may have a rectangular cross-section of 1 in by 2 in. The fastening mechanism used for removably attaching the lever 400 with the channel may be a 2 in to 2.5 in×⅜ in bolt arrangement. Additionally, the detachable grip 406 at the top end portion 404 of the lever 400 may be a plastic or rubber grip 4.5 in long covering the top end portion 404 of the lever 400 to further facilitate the user's operation of the apparatus 100.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, and to thereby enable others skilled in the art to best utilize the present invention and various embodiments with various modifications as are suited to the particular use contemplated. It is understood that various omissions and substitutions of equivalents are contemplated as circumstances may suggest or render expedient, but these are intended to cover the application or implementation without departing from the spirit or scope of the claims of the present invention.

What is claimed is:

1. An apparatus for lifting a vehicle, the apparatus comprising:
a frame assembly, the frame assembly comprising
a pair of frame links distanced apart from each other, and
a plurality of connecting members, each connecting member of the plurality of connecting members connected in-between the pair of frame links;
an arm assembly coupled to the frame assembly for providing support to the frame assembly, the arm assembly comprising at least one arm link and a support stand, wherein a first end portion of the at least one arm link is hinged to the frame assembly and the support stand coupled to a second end portion of the at least one arm link; and
a lever coupled to a connecting member of the plurality of connecting members, the lever capable of pivotally rotating the frame assembly from a rest position to an upright position,
wherein the apparatus positioned below a frame of the vehicle with the frame assembly rotated to the upright position from the rest position enables lifting of the vehicle from a ground surface, and
wherein the support stand coupled to the at least one arm link of the arm assembly supports the frame assembly in the upright position.

2. The apparatus of claim 1, wherein the vehicle is a motorcycle.

3. The apparatus of claim 1, wherein the pair of frame links are arranged in a longitudinally parallel arrangement.

4. The apparatus of claim 1, wherein the plurality of connecting members are welded in-between the pair of frame links.

5. The apparatus of claim 1, wherein the at least one arm link comprises a pair of spaced apart arm links with a first end portion of each arm link hinged to the frame assembly and second end portion of each arm link connected to an arm link connecting member.

6. The apparatus of claim 5, wherein each of the pair of spaced apart arm links are hinged to a connecting member of the plurality of connecting members.

7. The apparatus of claim 5, wherein the frame of the vehicle rests on a frame link of the pair of frame links and on the arm link connecting member when the frame assembly assumes the upright position.

8. The apparatus of claim 1, wherein the connecting member comprises a flange arrangement defining a channel for removably receiving a bottom end portion of the lever.

9. The apparatus of claim 8, wherein the flange arrangement comprises a fastening mechanism for securing the bottom end portion of the lever to the connecting member.

10. The apparatus of claim 1, wherein the lever comprises a detachable grip at a top end portion of the lever.
